(19) United States
(12) Patent Application Publication
(10) Pub. No.: US 2004/0136191 A1
(43) Pub. Date: Jul. 15, 2004

(54) Holiday light net

(76) Inventor: David Bluford, Burkley, IL (US)

Correspondence Address: Tyrone Davis, C/O Davis & Kendall, PC, Suite 626, 188 West Randolph, Chicago, IL, 60601, US

(21) Appl. No.: 10/340,675

(22) Filed: Jan. 13, 2003

(51) Int. Cl. F21V 21/00

(52) U.S. Cl. 362/249; 362/252; 362/123; 362/806

(57) ABSTRACT

A decorative lighting system, having a flexible net to be placed over a wall, tree, or bush, allowing an electrical current to pass through and illuminate Christmas or holiday lights placed randomly along the net.

### CROSS REFERENCE TO RELATED APPLICATIONS

### FIELD OF THE INVENTION

The invention relates to a device for mounting holiday lights. More particularly, the present invention relates to a net that allows for the attachment of various interchangeable holiday light designs. The lights are interchangeable and can be placed in unique and distinctive patterns. The lights are holiday theme shaped i.e. Christmas trees, candles, pumpkins, firecrackers, etc. The net remains in place and the lights are placed or removed from the net thereby eliminating problems encountered with display rearrangements.

### STATEMENT REGARDING FEDERALLY SPONSORED RESEARCH AND DEVELOPMENT

### BACKGROUND OF THE INVENTION

Strings of miniature lights with standardized sizes have become a tradition for decoration and ornamentation during the holiday seasons such as Christmas, New Year's, Hanukah, Independence Day, and Halloween. Celebrations, as well as, for purposes of ornamental displays in advertising/product promotion have adopted strings of miniature lights. These light string operate with low voltage, small or miniature light bulbs, connected in a series along connected wires that are properly insulated for either indoor or outdoor usage. Through mass production these light strings have become inexpensive to produce and operate with a low amount of electricity for highly visible, pinpoint illumination.

However, it is difficult for creative individuals to string the lights in such a manner that they display a unique design. Often the long strings of lights become tangled and are almost impossible to arrange. Artistic individuals who try to apply certain arrangements to bushes, trees, poles and pillars encounter numerous problems. More importantly, because of the difficulty of arranging and detangling the lights, it is rare that a change in pattern or display manner is done during the holiday season. As such, a need has developed so as to provide a system whereby the pattern display can be interchanged in a simple, quick, and easy manner while preventing the problem of removing or detangling of the light cord.

### SUMMARY OF THE INVENTION

The present invention provides a holiday lighting display system that comprises a flexible sheet or mesh material with a plurality of light receiving receptacles. The apparatus (device) incorporates interchangeable lights in the shape of Christmas trees, candles, stars, etc, and other holiday theme paraphernalia, while keeping the lights in a uniform pattern. Thus, preventing tangling of the light strings and providing an easy and quick method of changing the light theme and pattern.

It is an objective of the present invention to provide a holiday theme lighting display.

Another objective of the invention is to provide a quick change light pattern method.

It is another objective of the invention to provide a quick and easy light stringing method for bushes and trees.

It is an object of the invention to provide a light arrangement that keeps the light string from being easily tangled.

Finally, it is an object of the invention to provide a light string with interchangeable and relatively inexpensive lights.

These and other objects and advantages of the present invention will become apparent from a reading of the attached specification and claims.

### BRIEF DESCRIPTION OF THE DRAWINGS

The accompanying drawings, which are incorporated in and form part of the specification, illustrate an embodiment of the present invention and together with the description, serve to explain the principles of the invention. In the drawings:

FIG. 1. shows an embodiment of the invention.

FIG. 2. show another embodiment of the invention.

FIGS. 3-4. show a detail of the lights.

FIG. 5 show a detail of the lamp base.

### DETAILED DESCRIPTION OF THE INVENTION

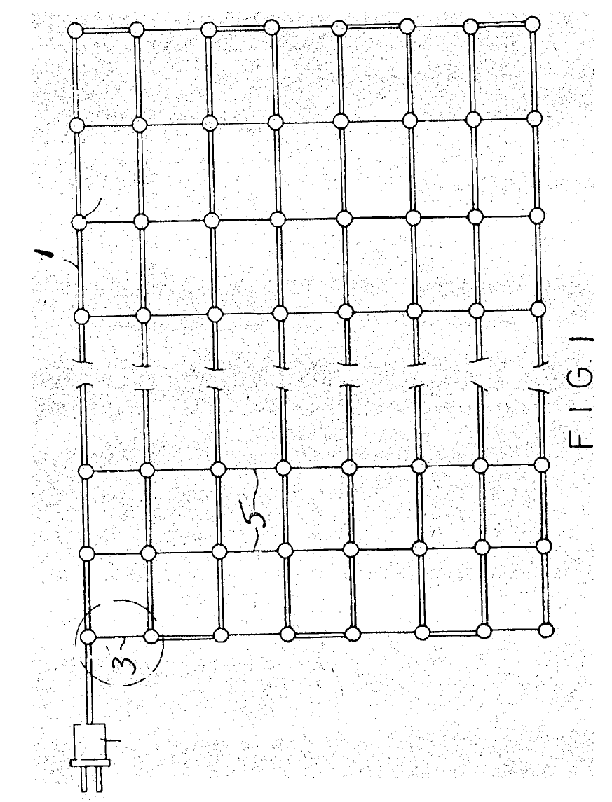

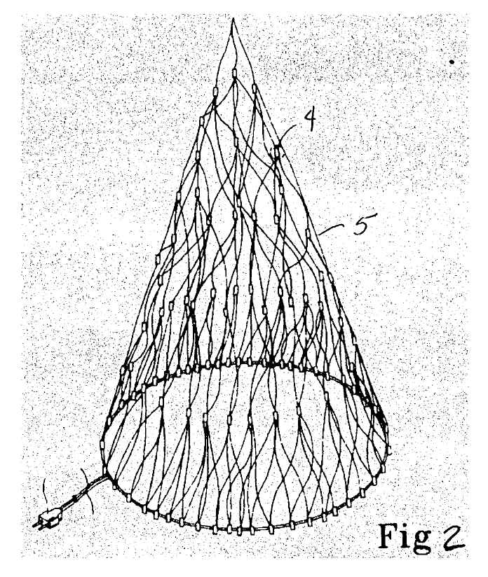

The invention provides a net or blanket material to be hung on a wall, or draped on trees, bushes and the like. The material incorporates a negative and positive line with a plurality of contact points that can receive illuminating devices. As shown in FIGS. 1 and 2, a material such as a flexible sheet (1) is placed over a wall, tree, or bush (not shown). The sheet has a plurality of contact points (3) adapted to receive illuminating devices (4). The flexible sheet has a grid (5) of positive and negative lines running in tandem that allows the illuminating devices (4) to be placed randomly along the sheet and receive the proper current to be illuminated.

The illuminating devices (4) can be in any shape or size such as, Christmas trees, candles, stars, wreaths, flags, and designs for all occasions. The illuminating devices (4) can be designed for standard electric current or modified for low voltage operation. The illuminating devices (4) snap into place along the grid (5) allowing complete creative freedom by the user.

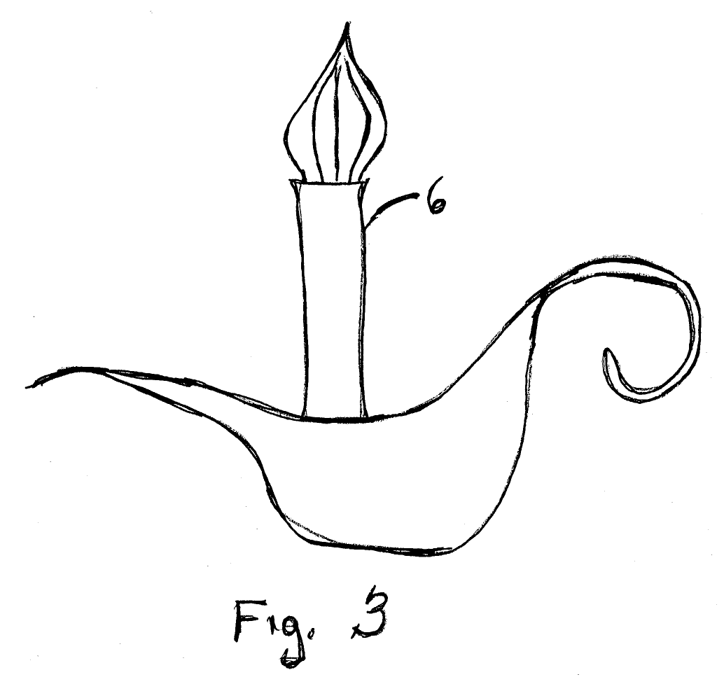

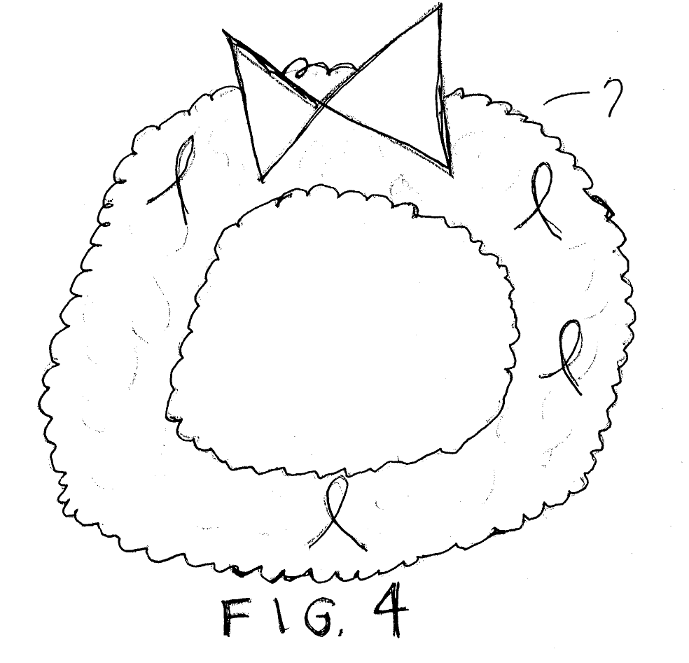

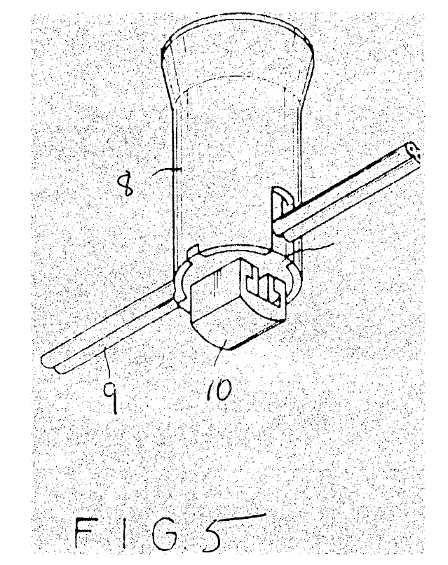

Referring to FIGS. 3 and 4, the illuminating devices (4) can be in a variety of shapes and sizes. The traditional candle (6), Christmas wreath (7), and colored stars (not shown) shapes are formed as lenses and attached to a lamp base (8). The lamp base (8) snaps unto the grid (9) with the contact piece (10) and illuminates the lens.

The invention has been described in detail with particular reference to certain preferred embodiments thereof, but it will be understood that variations and modifications can be effected within the spirit and scope of the invention.

### Parts List

1. Flexible Sheet

2. Tree/Bush

3. Contact Points

4. Illuminating Devices

5. Grid

6. Candle lens

7. Wreath Lens

8. Lamp Base

9. Grid

10. Contact Piece

Embodiments of the invention in which an exclusive property or privilege is claimed are defined as follows:

1. An apparatus for decorative illumination comprising:
a flexible net;
a plurality of contact points attached to said flexible net and said flexible net having an electrical current traveling therethrough; and
an illuminating device attached to said contact point.

2. The apparatus as recited in claim 1 wherein said flexible net is arranged in a grid thereby allowing said illuminating device to be randomly placed on said net.

3. The apparatus as recited in claim 2 wherein said illuminating device is in the shape of a Christmas ornament.

4. The apparatus as recited in claim 3 wherein said illuminating device is in the shape of a Halloween figure.

5. The apparatus as recited in claim 4 wherein said illuminating device is in the shape of a flag.

6. The apparatus as recited in claim 2 wherein said illuminating device is in the shape of a fireworks.

7. A method decorative illuminating comprising the steps of:
placing a flexible net over an object, said flexible net having contact points along said flexible net and having an electrical current traveling therethrough; and
attaching a plurality of illuminating devices to said contact points in a randomly selected pattern along said flexible net.

8. The method as recited in claim 7 wherein said illuminating devices are in the shape of holiday figures.

9. A decorative holiday lighting system comprising:
a flexible net in a grid pattern having a electrical current running therethrough;
contact points located along the surface of said grid; and
a plurality of lights in the shape of holiday figures randomly placed along the contact points of said grid.
